(19) United States
(12) Patent Application Publication
(10) Pub. No.: US 2003/0044482 A1
(43) Pub. Date: Mar. 6, 2003

(54) Integrated decorator coupler and food decorating assembly

(76) Inventors: Daniel P. Stachowicz, Westchester, IL (US); Britt Haslow, Palatine, IL (US); Kathie Weber, Morton Grove, IL (US); Howard W. Wurster JR., Kenmore, NY (US)

Correspondence Address: KENYON & KENYON, 1500 K STREET, N.W., SUITE 700, WASHINGTON, DC, 20005, US

(21) Appl. No.: 09/940,805

(22) Filed: Aug. 29, 2001

(51) Int. Cl. A21C 1/00

(52) U.S. Cl. 425/208

(57) ABSTRACT

The present invention provides for a dual-functioning decorator coupler for insertion into a bag fabricated to hold food filling. The decorator coupler has a decorative opening and a non-decorative opening. The non-decorative opening is shaped to remain within the interior of the bag and the decorative opening is designed to extrude filling in a first decorative shape. The decorator coupler is also attachable to a decorative tip for extruding filling in a second decorative shape.

### FIELD OF INVENTION

The present invention generally relates to a food decorating assembly particularly useful in commercial food preparation. In particular, the present invention is directed to a dual-functioning decorator coupler. The decorator coupler decorates food in a first decorative shape without any additional attachments and is also capable of retaining a decorative tip to decorate food in a second decorative shape.

### BACKGROUND OF INVENTION

In the food industry, food presentation is often an important consideration. As such, it has been a long-standing practice to use a food decorating assembly to decorate food. These assemblies generally include a flexible bag for holding food filling or topping and a decorative tip with a decorative opening that fits into the bag and protrudes through an opening in the bottom of the bag. As the bag is squeezed, the filling extrudes through the tip in a decorative shape onto the food.

Decorative tips are available in different sizes and shapes, which provides for a wide range of food decorating options. The usual practice is to insert a selected decorative tip into the bag, fill the bag with a selected food filling, and squeeze the bag to push the filling out in a selected decorative shape onto the food. The bag must be emptied of filling before inserting another decorative tip. There are several disadvantages with this practice. First, this process is time consuming since any time a new design is desired, the user must empty the bag and insert a new tip and then re-fill the bag with filling. Second, this process is untidy if the bag is not completely cleaned of filling.

To alleviate some of these problems, a coupler assembly kit was developed that includes a flexible bag, a coupling tube with a smooth opening and an externally threaded portion, a retaining nut with an internally threaded portion, and a set of decorative tips. This kit generally includes all these components and requires assembly before beginning the decorating operation. To assemble this kit, the coupling tube is first inserted into the bag. The externally threaded portion of the coupler protrudes through an opening in the bottom of the bag. A decorative tip is then securely attached to the coupling tube by means of the retaining nut. This assembly kit allows for several different tips to be utilized without the need to empty filling from the bag.

This coupler assembly kit, however, also has several deficiencies. First, since the coupler serves no decorative function by itself, the process of attaching a separate tip to the coupler requires additional time and manipulation of the assembly. Second, because this type of coupler assembly kit does not arrive preassembled, the user must insert the coupler into the bag and then fill the bag with filling. After these two steps, in order to perform the decorating operation, the user must attach a decorative tip to the coupler. This process is also time-consuming and potentially untidy and unsanitary as the user is touching and manipulating different pieces of the kit in order to prepare for the decorative operation.

There is, therefore, a need for a food decorating assembly that solves these problems. In particular, there is a need for a decorating assembly that requires less time and handling to prepare for the decorating operation. The present invention provides a decorator coupler that functions as both a decorative tip and as a coupler to which different decorative tips may be attached. This decorator coupler may be part of a preassembled food decorating assembly. In this assembly, a flexible bag capable of holding food filling is preassembled with the decorator coupler seated at the bottom of the bag and the bag is pre-filled with filling.

### SUMMARY OF THE INVENTION

In one aspect of the present invention, there is provided a dual-functioning decorator coupler for insertion into a bag fabricated to hold food filling. The decorator coupler has a decorative opening designed to extrude the filling onto food in a first decorative shape. The decorator coupler is also attachable to a decorative tip for extruding filling in a second decorative shape.

In one embodiment of this aspect of the present invention, there is provided a food decorating assembly including a flexible bag capable of receiving and holding food filling, a decorator coupler, and a retaining nut designed to engage a decorative tip to the decorator coupler. In a preferred embodiment, there is provided a preassembled food decorating assembly in which a flexible bag capable of receiving and holding filling contains a decorator coupler seated at the lower end of the flexible bag and is pre-filled with filling.

In another aspect of the present invention, there is provided a method of decorating food comprising providing filling in a flexible bag containing a decorator coupler protruding through the lower aperture of the bag and providing pressure on the bag to push filling through the decorator coupler in a first decorative shape and onto food. This method also comprises the optional, additional step of attaching a decorative tip to the decorator coupler and extruding filling in a second decorative shape.

### BRIEF DESCRIPTION OF THE DRAWINGS

FIG. 1 shows a decorator coupler according to one embodiment of the present invention.

FIG. 2 shows an alignment of a decorator coupler, a decorative tip, and a retaining nut according to one embodiment of the present invention.

FIG. 3 shows a flexible bag filled with food filling and a decorator coupler protruding from the bottom of the bag according to one embodiment of the present invention.

FIG. 4 shows a flexible bag filled with food filling and a decorative tip attached to a decorator coupler by means of a retainer nut according to one embodiment of the present invention.

### DETAILED DESCRIPTION OF ILLUSTRATED EMBODIMENTS

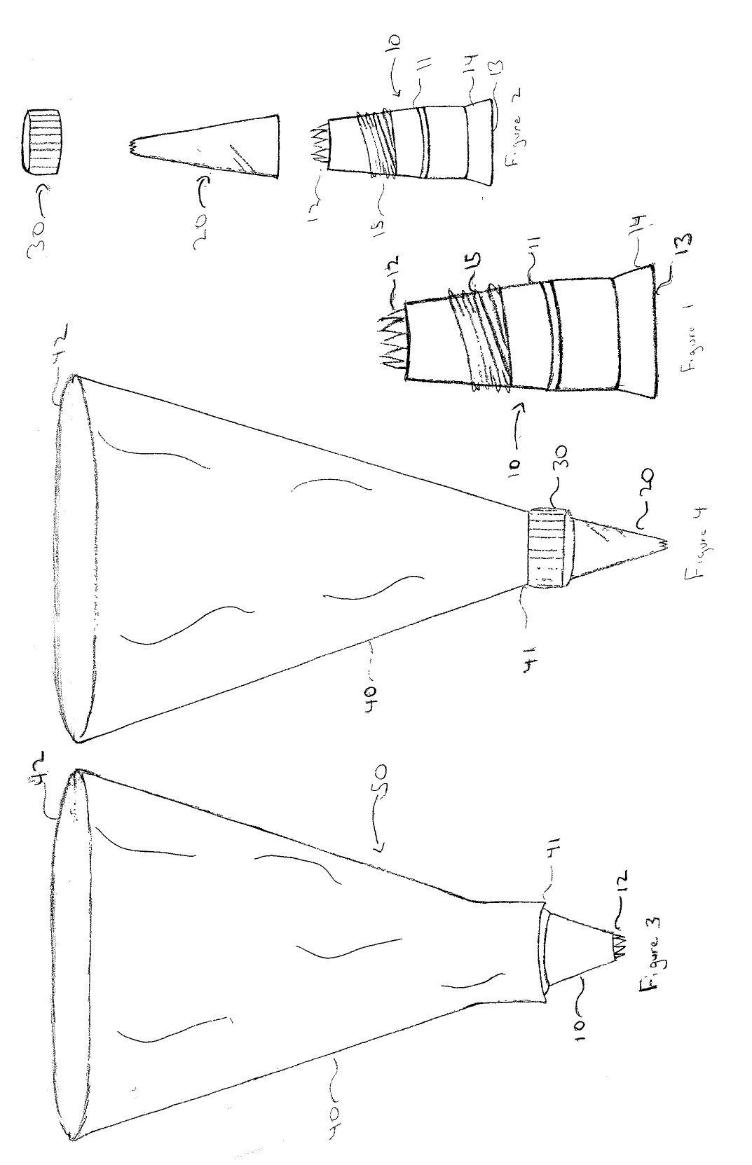

FIG. 1 shows one embodiment of a decorator coupler 10 according to the present invention for insertion into the bottom of a flexible bag fabricated to hold food filling. The decorator coupler 10 has a hollow conical configuration comprising a main body 11, an upper end including a decorative opening 12 and a lower end including a non-decorative opening 13. The decorative opening is designed to extrude filling in a first decorative shape. The non-decorative opening is designed to receive and channel filling from the bag to the decorative opening. The decorator coupler tapers downwardly from the non-decorative opening to the decorative opening. Although this tapered design is sufficient to hold the decorator coupler 10 in place in the bottom of the bag, the lower end of the decorator coupler 10 may define a slightly flared shoulder 14 designed to securely seat the coupler in the bag. Alternatively, the lower end of the decorator coupler 10, may be designed in any shape that allows the non-decorative opening 13 to remain in the interior of the bag when pressure is applied to the bag.

The decorative opening 12 is designed to extrude filling in a first decorative shape. The size and configuration of the decorative opening determine the decorative shape. In the illustrated embodiment, the decorative opening 12 is in the shape of a star. Non-limiting examples of other possible shapes of the decorative opening include drop flower, leaf, petal, round, straight ribbon, curved ribbon, closed star, star-cut cross, Irish heart, flat lettering, multiple star, and basket weave shapes.

In addition to serving decorative function, the decorator coupler is also capable of retaining a decorative tip. This decorative tip extrudes filling in a different decorative shape than the decorator coupler 10. As shown in FIGS. 1 and 2, in one embodiment, the main body 11 of the decorator coupler 10 may include an externally threaded portion 15. In this embodiment, the retaining nut 30 has an internally threaded portion (not shown) which engages the externally threaded portion of the decorator coupler. The decorative tip 20 is sized to communicate with both the decorator coupler 10 and the retaining nut 30. In using this embodiment, the decorative tip 20 is placed on the upper end of the decorator coupler 10. The retaining nut 30 is placed over the decorator coupler such that the internally threaded portion of the retaining nut 30 engages the externally threaded portion 15 of the decorator coupler 10. The retaining nut is then screwed on to secure the decorative tip 20 onto the decorator coupler 10. It is understood to those skilled in the art that any other method of securing the decorative tip 20 to the decorator coupler 10 may be utilized. For example, the decorator coupler and retaining nut need not include threaded portions. The decorator coupler and retaining nut could have surfaces such that when the retaining nut is placed over the decorator coupler and downward pressure is applied to the retaining nut, the retaining nut is “snapped” onto the decorator coupler, thereby securing the decorative tip 20 onto the decorator coupler. Alternatively, the retaining nut may include flanges to lock it in place over the decorator coupler.

The present invention also provides for a food decorating assembly including many of the components described above. As seen in FIG. 3, the food decorating assembly 50 according to the present invention includes a flexible bag 40 having an upper end including an upper aperture 42 and a lower end including a lower aperture 41. The upper aperture 42 is sized to receive filling and the lower aperture 41 is sized to dispense filling. The bag 40 may comprise any flexible material capable of holding food filling. For example, the bag 40 may comprise plastic, paper, or fabric. The filling may include a wide variety of foods sufficiently viscous to hold their shape. For example, the filling could include cake icing or frosting, whipped topping, mashed potatoes, or cheese.

As seen in FIG. 3, the food decorating assembly 50 also includes a decorator coupler 10 and a retaining nut (not shown), described in more detail above. The decorator coupler is insertable into the bag with the decorative opening 12 protruding through the lower aperture 41 of the bag. The food decorating assembly 50 may be provided with the decorator coupler 10 seated at the lower end of the bag 40. In one embodiment, the bag 40 is provided with the lower end of the bag 40 sealed. In this embodiment, the entire decorator coupler is contained in the interior of the bag 40. When the lower end of the bag 40 is opened, creating the lower aperture 41, the decorator coupler 10 protrudes through the lower aperture 41. It is understood to those skilled in the art that the decorator coupler 10 is shaped in a manner that allows the lower end of the coupler to remain within the interior of the bag 40. A cap that fits over the decorator end of the decorator coupler may also be included in the assembly.

In an alternative embodiment, the decorator coupler 10 arrives with the lower end of the decorator coupler already extending through the lower aperture 41. In this embodiment, a protective covering surrounds the decorator coupler in order to maintain the cleanliness of the decorator coupler before use. In this alternative embodiment, the decorator coupler has a cap fitted into the decorative opening to prevent leakage of filling before or between uses.

In one embodiment the food decorating assembly 50 is preassembled. In particular, the food decorating assembly is provided with a decorator coupler 10 seated at the lower end of the bag and pre-filled with filling. In this embodiment, the decorating food assembly is ready to use. There is no need to manually insert the decorator coupler into the bag or fill the bag with filling.

In an alternative embodiment, the food decorating assembly 50 is provided partially pre-assembled. In particular, the decorator coupler 10 is seated at the lower end of the bag, but the bag is not pre-filled with filling. In this alternative embodiment, the user may choose which type of food filling to use and then may fill the bag with this selected filling. In both embodiments, the user does not need to manually insert the decorator coupler into the bag thereby reducing unnecessary handling of the assembly components. Furthermore, in both embodiments, because the decorator coupler has a decorative opening, the food decorating assembly does not require any additional decorative tips.

The decorator coupler 10 allows the user, however, to use different decorating tips if it is so desired. As mentioned above, in addition to serving a decorative function by itself, the decorator coupler 10 is also capable of retaining a decorative tip 20. This allows the user to decorate food in shapes different than the shape defined by the decorative opening 12 of the decorator coupler 10. As seen in FIG. 4, this decorative tip 20 is coupled to the decorator coupler by means of the retaining nut 30.

Using this food decorating assembly 50 requires few simple steps. In one embodiment, the assembly 50 is provided completely preassembled. As mentioned above, in this embodiment the assembly is provided with a decorator coupler 10 seated at the lower end of the bag 40 and is pre-filled with filling. The user simply removes the assembly 50 from its packaging and squeezes the bag 40 to push filling through the decorator coupler 10 and onto the food. In an alternative embodiment, the food assembly arrives partially preassembled. In this embodiment, the decorator coupler 10 is seated at the lower end of the bag but the bag is not pre-filled with filling. The end of the bag may be cut to hold the decorator coupler or the end user may cut the end of the bag and position the decorator coupler at the cut end. In this alternative embodiment, the user chooses which filling to use to decorate the food. The user then pours the filling in the bag 40 through the upper aperture 42. The bag 40 is then closed by clipping, folding, or twisting the upper end of the bag 40. The user then squeezes the bag 40 to push filling through the decorator coupler 10 and onto the food.

If a different decorative design is desired, a decorative tip corresponding to the selected design is placed on the upper end of the decorator coupler 10. The user then places the retaining nut 30 in contact with the decorator coupler 10. If the decorator coupler 10 has an externally threaded portion 15 and the retaining nut has an internally threaded portion, the user screws on the retaining nut 30 to secure the decorative tip 20 onto the decorator coupler 10. It is not necessary for the externally threaded portion 15 of the decorator coupler 10 to protrude through the lower aperture 41 of the flexible bag. The externally threaded portion 15 may remain inside the bag and the user can screw the retaining nut over the bag and engage the internally threaded portion of the retaining nut 30 to the externally threaded portion 15 of the decorator coupler 20. After the decorative tip 20 is securely attached to the decorator coupler 10, the user then squeezes the bag 40 to push the filling through the decorator coupler and onto the food.

The user can use this food decorating assembly 50 to decorate various types of foods with various types of filling. For example, the user can use cheese filling to decorate crackers and vegetable sticks; cake icing to decorate cakes and cupcakes; whipped topping to decorate fruits and other dessert items. The user can also use this food decorating assembly to present food in a decorative fashion. For example, the user can fill the bag 40 with mashed potatoes and extrude the mash potatoes onto a plate in a decorative shape. The present invention is not limited to the preceding uses. It is understood to those skilled in the art that any sufficiently viscous foodstuff can be utilized with the food decorating assembly 50. The assembly and product according to the present invention has been described with respect to several exemplary embodiments. It can be understood, however, that there are many other variations of the above-described embodiments that will be apparent to those skilled in the art, even where elements have not explicitly been designated as exemplary. It is understood that these modifications are within the teaching of the present invention, which is to be limited only by the claims appended hereto.

We claim:

1. A decorator coupler for insertion into a bag fabricated to hold filling, comprising:
a hollow tube having a non-decorative opening and a decorative opening, the non-decorative opening shaped to remain within the interior of the bag, the decorative opening designed to extrude filling in a first decorative shape, wherein the decorator coupler is attachable to a decorative tip for extruding filling in a second decorative shape.

2. The decorator coupler of claim 1, wherein the decorator coupler has an externally threaded portion capable of engaging with a retaining nut.

3. The decorator coupler of claim 1, wherein the decorator coupler tapers downwardly from the non-decorative opening to the decorative opening.

4. The decorator coupler of claim 1, wherein the coupler has a shoulder to securely seat the coupler in the bag.

5. A food decorating assembly comprising:
a flexible bag having an upper end including an upper aperture and a lower end including a lower aperture, the upper aperture sized to receive filling and the lower aperture sized to dispense filling;
a decorator coupler having a decorative opening, the decorative opening designed to extrude filling in a first decorative shape, the decorator coupler insertable into the bag with the decorative opening protruding through the lower aperture of the bag wherein the decorator coupler is attachable to a decorative tip for extruding filling in a second decorative shape; and
a retaining nut devised to engage a decorative tip to the decorator coupler.

6. The food decorating assembly of claim 5, wherein the decorator coupler has an externally threaded portion capable of engaging with the retaining nut.

7. The food decorating assembly of claim 5, further comprising at least one decorative tip sized to communicate with the decorator coupler and the retaining nut.

8. The food decorating assembly of claim 5, wherein the bag comprises plastic or fabric.

9. The food decorating assembly of claim 5, wherein the flexible bag is preassembled with a decorator coupler seated at the lower end.

10. The food decorating assembly of claim 5, wherein the flexible bag is pre-filled with filling.

11. A method of decorating food comprising:
providing filling in a flexible bag, the bag having an upper aperture sized to receive filling and a lower aperture sized to dispense filling, the bag having a decorator coupler protruding through the lower aperture, the decorator coupler having a decorative opening designed to extrude filling in a first decorative shape; and
providing pressure on the bag to push filling through the decorator coupler and onto the food.

12. The method of claim 11 further comprising attaching a decorative tip to the decorator coupler, the decorative tip extruding filling in a decorative shape different from that made by the decorator coupler.

13. The method of claim 12, wherein the tip is attached by a retaining nut to the decorator coupler, the retaining nut designed to engage the decorative tip to the decorator coupler.

14. The method of claim 12, wherein a retaining nut secures the decorative tip to the decorator coupler.
